(19) United States
(12) Patent Application Publication
(10) Pub. No.: US 2023/0340781 A1
(43) Pub. Date: Oct. 26, 2023

(54) Covering element of a reveal

(71) Applicant: MIR SOLUTION S.R.L., Bergamo (IT)

(72) Inventor: Raffaele BELLINI, Bergamo (IT)

(73) Assignee: MIR SOLUTION S.R.L., Bergamo (IT)

(21) Appl. No.: 18/303,574

(22) Filed: Apr. 20, 2023

(30) Foreign Application Priority Data
Apr. 21, 2022 (IT) 102022000007928

(51) Int. Cl. E04B 1/76

(52) U.S. Cl. CPC E04B 1/7641; E04B 1/7629; E04B 2001/742

(57) ABSTRACT

A covering element of a reveal, wherein covering element comprises supporting structure made of wood comprising first, second and third panel rigidly connected to each other in series, wherein, second panel is interposed between first and third panel in series. The first and third panel are parallel to each other, they are perpendicular to second panel, and they extend on same side of second panel. The first and third panel are connected to second panel at respectively two opposite end portions of second panel so that first, second and third panel form a pocket, wherein, with reference to a direction perpendicular to second panel, third panel has an extension smaller than extension of first panel, and wherein covering element comprises filling assembly housed in pocket, and a layer made of first insulating material which continuously covers first and second panel on opposite side with respect to said pocket.

### TECHNICAL FIELD OF THE INVENTION

The present invention concerns a covering element of a reveal of a compartment for a fixture, in particular for the purposes of insulating covering.

### BACKGROUND ART

The term “reveal” (or intrados) refers to the visible internal surface of a compartment for a fixture, such as a window or a French door, at which the distance between the interior and exterior of the building is reduced.

As part of the thermal insulation of new buildings or already existing buildings undergoing energy redevelopment, it is known to cover the wall of the building, typically outside the building, with a thermal coat (i.e. a system of panels providing the desired thermal insulation). It is also known to thermally insulate the reveal, for example by continuing in situ the construction of the cover on the reveal. In fact, thermal bridges (i.e. points of direct heat flow from the inside to the outside of the building or vice versa, depending on the temperature difference between the inside and outside of the building) can be generated at the reveal, which can cause energy waste and/or the formation of mould or stains.

### SUMMARY OF THE INVENTION

In the aforesaid scope of insulating covering of buildings, and in particular of the reveal of a fixture compartment (at least for the part left free by the fixture), the Applicant has realized that the operation of in situ realization of the thermal coat on the reveal may involve some problems, such as for example an increase in costs and/or timing and/or complexity of the intervention by the specialized workers (cover and/or fixture installing worker), and/or interference with the anchoring of the accessory devices to the fixtures, such as for example, darkening device (roller shutter, shutters, blinds, sun awnings or pergolas) and/or protection devices (e.g. balustrades, banisters, gates or railings).

The Applicant has therefore addressed the problem of realizing a covering element of a reveal (and at the same time of a facade part contiguous to the reveal) that provides the desired thermal insulation (e.g., limiting the occurrence of thermal bridges), that facilitates the anchoring of the accessory devices to the fixtures (directly and/or through the anchoring to the covering element of support elements of the accessory devices, e.g., screws, hinges, plates with screws/bolts, etc.), and that is at the same time structurally robust, durable, economical, and/or easy and/or quick to install.

According to the Applicant, the aforesaid problem is solved by a covering element of a reveal in accordance with the attached claims and/or having one or more of the following characteristics.

According to one aspect the invention concerns a covering element of a reveal.

Preferably said covering element comprises a supporting structure made of wood comprising a first, a second and a third panel rigidly connected to each other in series, wherein:
the second panel is interposed between the first and third panel in the series;
the first and third panel are parallel to each other, they are perpendicular to the second panel and they extend on the same side of the second panel;
the first and third panel are connected to the second panel at respectively two opposite end portions of the second panel so that the first (in part), the second and the third panel form a pocket.

Preferably, with reference to a direction perpendicular to the second panel, the third panel has an extension smaller than an extension of the first panel.

Preferably said covering element comprises a filling assembly housed in said pocket.

Preferably said covering element comprises a layer made of a first insulating material which continuously covers the first and second panel on opposite side with respect to said pocket.

Each panel has a respective main extension plane, a respective first and second face parallel to the respective main extension plane and a thickness orthogonal to the main extension plane. Depending on the context, a reference to the panel, in particular to the orientation of the panel in the space, may imply a reference to the respective main extension plane.

The covering element has a main extension direction. The term “longitudinal” means a direction parallel to the main extension direction. “Orthogonal section” means a section orthogonal to the main extension direction.

For the purposes of the present invention, “insulating material” means any material having a thermal conductivity (λ) less than or equal to 0.20 W/(m*K)

According to the Applicant, the layer of insulating material which continuously covers the first and second panel on the opposite side with respect to the pocket allows to confer the appropriate thermal insulation properties to the covering element, as well as to keep these properties constant throughout the entire longitudinal extension of the covering element. The Applicant has further observed that the supporting structure made of wood (which is typically an insulating material) also contributes to the aforesaid thermal insulation properties.

The Applicant has also observed that the combination of the use of wood to realize the supporting structure and the aforesaid arrangement of the three panels to form a pocket (i.e., the three panels in orthogonal section form a “u” at the pocket) allows to obtain a covering element having a high overall structural resistance. According to the Applicant, this is due, on the one hand, to the use of wood that has excellent structural strength properties (as well as lightness, availability on the market and/or purchase/processing cost). On the other hand, the aforesaid mutual arrangement of the panels in which two contiguous panels are orthogonal to each other, confers a high rigidity to the individual panels (which might otherwise for example tend to flex and/or deform when subjected to loads during use of the covering element). In this way, the covering element is able to anchor the accessory devices effectively and/or in a durable manner over time. In addition, a high regularity of the (right) angle formed between two contiguous panels and/or of the planarity of the faces of the panels is favoured, with advantages in terms of simplicity and/or speed of installation of the covering element.

Yet, the aforesaid arrangement of the panels that creates a distance between the first and third panel (maintained by the filling assembly housed in the pocket), and the extension of the third panel in the direction perpendicular to the second panel smaller than the similar extension of the first panel (in other words the first panel has a free face portion, i.e. not affected by the pocket), create two mutually orthogonal surfaces for resting to a corner of the building (the corner of the reveal contiguous to the facade) that oppose the rotational forces of the covering element around the corner, thus contributing to the stability of the fastening of the covering element to the building.

In addition, the realization of the pocket allows to have a space to house the filling assembly, which can advantageously perform one or more functions according to needs (e.g., thermal insulation, anchoring of accessory devices, structural strengthening, etc.), as described in detail below.

For example, the aforesaid arrangement of the panels and the filling assembly housed in the pocket allow heavy and/or bulky accessory devices (such as in the case of balustrades or railings) to be anchored to the covering element. In fact, in this case the accessory device can be anchored (e.g., through one or more support elements) to both the first and third panel, without any failure or deformation of one or both panels taking place, with possible occurrence of defects in the facade and/or defective anchorings.

The Applicant has realized that the covering element according to the present invention lends itself to being designed in a versatile way to comply with the desired dimensions (i.e. it lends itself to being made in different sizes and/or different ratios of its components according to the needs of the work site) and also for being produced and transported as a prefabricated element, avoiding that professional workers must carry out the covering of the reveal on the work site, for example by sequentially installing the various elements necessary for covering the reveal and for anchoring the accessory elements. This makes it possible to simplify and/or significantly speed up the operations for covering the reveal.

The present invention in one or more of the above aspects may have one or more of the following preferred features.

Preferably said supporting structure has a constant orthogonal section when moving along the main extension direction.

Preferably said supporting structure comprises a fourth panel, and it preferably consists only of said first, second, third and fourth panel. The Applicant considers that this number of panels achieves a good compromise between simplicity of realization and functionality.

Preferably said fourth panel is rigidly connected in series (only) to the first panel. Preferably said fourth panel is parallel to the second panel (or perpendicular to the first and third panel). In this way, the advantages of strength and structural stability mentioned above are realized.

Preferably said fourth panel extends in the opposite direction with respect to an extension direction of the second panel. Preferably the second and fourth panel are connected to the first panel at two respective opposite end portions of the first panel. In other words, in orthogonal section, the fourth, the first, and the second panel (in series with each other) have a configuration similar to a “z” having the central section (the first panel) orthogonal to the two end sections (second and fourth panel). In this way, the entire face of the fourth panel opposite to the pocket realizes an abutment surface for the fixture, with advantages in terms of simplicity and/or stability of installation of the covering element.

Preferably said layer in the first insulating material also continuously covers a (first) face of the fourth panel facing the first panel (e.g., a thickness of the layer made of the first insulating material is equal to a size of a portion of the first face of the fourth panel protruding from a second face of the first panel). In this way the thermal insulation properties of the covering element are uniformed and/or improved.

Preferably said first, second, third, and preferably fourth panel have a rectangular plan shape. Preferably, in orthogonal section, the first, second, third and preferably fourth panel have a rectangular shape. In this way the panels have a simple and rational shape (e.g., like a parallelepiped).

Preferably at each connection between two contiguous panels (in the series), one face of one of the two panels is coplanar with one side edge of another of the two panels (the side edge having extension along one thickness of the other of the two panels). In this way the structure adapts to the typical geometries of the buildings.

Preferably said first, second, third, and preferably fourth panel are composed of wood chips and/or flakes and/or lamellae glued and compressed to each other, more preferably they are OSB (Oriented Strand Board) panels. In this way the panels have the desired structural strength and thermal insulation properties, and at the same time they are inexpensive and/or easily available on the market. By “OSB panel” is meant a panel made of a plurality of layers, each layer comprising irregularly shaped wood chips and/or lamellae, wherein the chips/lamellae of each layer and of overlapping layers are glued and compressed to each other. Typically each layer, and/or a substantial part of said chips and/or lamellae, extends parallel to the respective main extension plane of the panel.

Preferably said fourth panel comprises a recess at a (second) face of said fourth panel opposite to the first panel (i.e., opposite to the first face of the fourth panel). Preferably said recess has a surface extension smaller than said face of the fourth panel opposite to the first panel (i.e., said second face).

Preferably said covering element comprises a support body which extends along an entire longitudinal length of the covering element.

Preferably said support body comprises a first portion housed (at least in part) in said recess. Preferably said covering element comprises an airtight element (for example a self-expanding adhesive) fixed (e.g. glued) to said first portion of the support body on the opposite side to said face of the fourth panel opposite to the first panel (i.e. the second face). In this way, the air tightness between the fixture and the covering element is achieved in a simple and/or effective way to limit any air vents.

Preferably said support body (e.g., as a single piece) comprises a second portion contiguous to said first portion and in contact with one face of said layer in the first insulating material opposite to the first panel. Preferably said covering element comprises a levelling aid device (e.g. a net) coupled to said second portion of the support body. In this way it is possible to provide a physical reference that facilitates the levelling operation, i.e. the application of a levelling product (e.g., slaked lime) to confer a uniform aesthetic appearance.

Preferably said filling assembly comprises (at least) one insulating element made of a second insulating material. Preferably said insulating element extends overall (even in the case of an insulating element composed of several separate parts) for at least 50%, more preferably for at least 60%, even more preferably for at least 70%, of an entire longitudinal length of the covering element. In this way, effective thermal insulation by the covering element is achieved. This insulating element can also act as a spacer element between the first and third panel.

In one embodiment said insulating element extends over the entire longitudinal length of the covering element. In other words, the filling assembly consists only of the insulating element that fills the entire pocket.

Preferably said filling assembly comprises one or more anchoring elements, preferably made of wood (preferably hardwood, e.g. maple, chestnut, beech, mahogany, walnut, oak, cherry, poplar, birch, ash, olive, rosewood), and more preferably each as a single body (e.g. each anchoring element is a solid wood block). In this way, one or more elements having both good thermal insulation properties (when made of wood) and excellent structural resistance properties are provided in the pocket for fixing to them additional elements subjected to loads during use of the covering element, as explained below.

Preferably each anchoring element has a longitudinal dimension (e.g., length) greater than or equal to 10 cm, preferably greater than or equal to 15 cm. In this way the anchoring element provides sufficient fastening versatility for the respective fastening element and/or support element. In fact, at least the support elements are typically fixed to the covering element on the work site, and therefore it may be advantageous to be able to fix these elements in a range of heights according to the work needs.

Preferably said insulating element and/or said one or more anchoring elements (more preferably said filling assembly along an entire longitudinal extension of the pocket) in orthogonal section occupy/ies entirely said pocket. In this way, the filling assembly is able to contribute to insulation and to keep the first and third panel at a distance effectively (and preferably continuously throughout the longitudinal extension of the pocket), thus preventing the pocket from collapsing, for example in the case of anchoring the accessory devices to the first and third panel. Furthermore, the free surface of the filling assembly (i.e. the surface opposite to the second panel) contributes to making the aforesaid surface for resting to the corner of the building.

Preferably said covering element comprises one or more fastening elements fixed to (e.g. in contact with) said third panel on the opposite side to said pocket. Preferably each fastening element is configured to fix said covering element to a facade of a building (preferably each fastening element is a metal corner plate). In this way one or more elements are provided capable of helping to achieve the stable and/or durable and/or reliable fastening of the covering element to the building.

Preferably each fastening element is fixed to said filling assembly, more preferably it is fixed to a respective anchoring element of said one or more anchoring elements. The Applicant has realized that it is advantageous to position each fastening element at a respective anchoring element as the latter has a high structural stability and is able to withstand high loads.

Preferably said covering element comprises one or more support elements (e.g., one or more hinges) of a respective accessory device (e.g., a roller shutter) for a fixture. Preferably each support element is fixed to the second panel and protrudes from a free face of said layer made of the first insulating material parallel to said second panel (in other words from a portion of the layer made of the first insulating material that covers the second panel). This provides an element that can withstand loads due to, for example, the weight and/or the movement of the accessory device. Preferably each support element crosses said second panel (e.g. orthogonally to the second panel) and is fixed to said filling assembly, more preferably it is fixed to a respective anchoring element of said one or more anchoring elements. The Applicant has realized that it is advantageous to position each support element at a respective anchoring element as the latter has a robust structure and is able to favour the stable and/or reliable and/or durable fastening of the support element.

In one embodiment said filling assembly is entirely made of wood, for example it can consist only of one or more wooden panels (e.g. OSB panels), or of a single solid wood beam. In this way, the realization of the covering element is simplified.

Preferably said first and/or second insulating material has thermal conductivity less than or equal to 0.15 W/(m*K), more preferably less than or equal to 0.10 W/(m*K), still more preferably less than or equal to 0.05 W/(m*K). In this way it is possible to improve the thermal insulation properties of the covering member.

Preferably, said first and/or second insulating material is selected from: sintered expanded polystyrene (EPS) reinforced with graphite, extruded expanded polystyrene (XPS), thermoplastic polyurethane (PUR), aerogel (of silica), polyisocyanurate (PIR), wood fiber, and combinations thereof. The insulation materials listed above are able to optimize the thermal insulation properties (as such materials typically have thermal conductivity less than or equal to 0.05 W/(m*K)) and at the same time are easily available on the market and/or have low costs.

Preferably said first insulating material is extruded foamed polystyrene (XPS). Preferably said second insulating material is expanded polystyrene (EPS) reinforced with graphite. The Applicant considers that such materials are particularly advantageous in terms of the ratio between insulating properties, mechanical strength and cost-effectiveness.

In one embodiment, the first and second insulating materials are the same material.

According to one aspect the invention concerns a covering system of a reveal comprising a first, a second and a third covering element, each according to any embodiment of the present invention, wherein said first, second and third covering element are coplanar with each other and fixed in series to form a “U”. In other words, a respective main extension direction of the second covering element (i.e., the central element) is perpendicular to a respective main extension direction of the first and third covering element (i.e., the terminal elements), with the first and third covering element extending on a same side of the second element and being parallel to each other. Such a covering system lends itself to being manufactured and transported as prefabricated, with significant advantages in terms of simplifying and/or speeding up the operations of covering at least three sides of the reveal. In fact, the covering system of the present invention reaches the work site already comprising all the elements necessary for covering at least three sides of the reveal, requiring only the positioning (and the fastening) to cover the reveal.

Preferably said covering system also comprises a fourth covering element according to any embodiment of the present invention, the fourth covering element being arranged such that said covering system has a rectangular shape. In other words, the fourth covering element closes the path formed by the first, second and third covering element, so that the covering system creates a frame that covers the entire reveal at the site. The Applicant has observed that such a configuration of the covering system is particularly advantageous if an accessory device is to be anchored to the lower side of the reveal, such as a banister and/or a rail.

According to one aspect the invention concerns a method for laying the covering system according to the present invention, said method comprising:
prefabricating the covering system;
covering (at least) the reveal on three sides with said covering system.

Preferably said laying method comprises (subsequently to said covering) fastening (at least) a respective support element to at least one covering element of the covering system.

Preferably, subsequently to said covering, said laying method comprises carrying out a levelling operation at a free surface of said layer in the first insulating material.

### BRIEF DESCRIPTION OF THE FIGURES

FIG. 1 schematically shows a perspective view of a longitudinal portion of a covering element of a reveal according to the present invention;

FIG. 2a schematically shows a section of the covering element of FIG. 1 on plane A;

FIG. 2b schematically shows a section of the covering element of FIG. 1 on plane B;

FIG. 3 shows schematically and in section the covering element of FIG. 1 installed to cover one side of the reveal;

FIG. 4 shows schematically and in section the reveal of a fixture compartment covered with a covering system according to the present invention.

### DETAILED DESCRIPTION OF THE INVENTION

The features and advantages of the present invention will be further clarified by the following detailed description of some embodiments of the present invention, presented by way of example and not limitation, with reference to the attached figures.

It is noted that the figures are not to scale and are for illustrative purposes only.

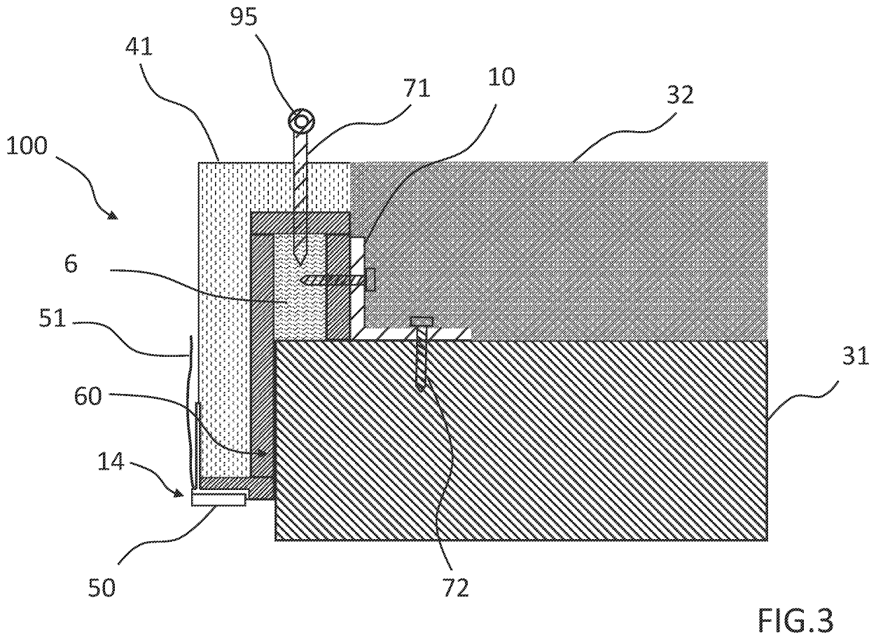

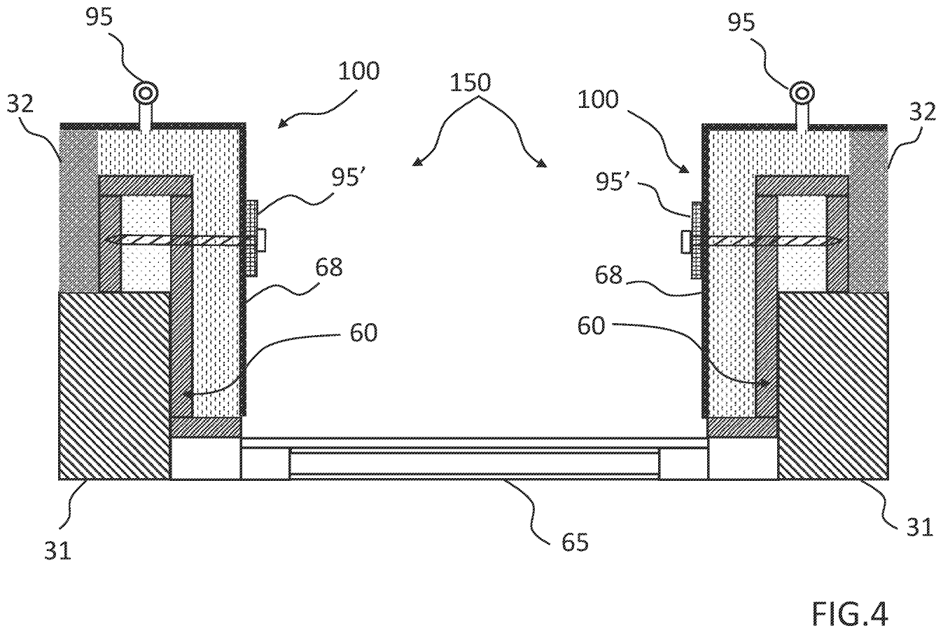

In the figures, reference numeral 100 indicates a covering element of a reveal 60 of a fixture compartment, such as for example a window 65, which when installed covers one side of the reveal 60 and at the same time also a portion of the facade (e.g. part of an external face of a masonry structure 31) of a building (as schematically shown in FIGS. 3 and 4).

The covering element 100 has a main extension direction 200, referred to as the longitudinal direction.

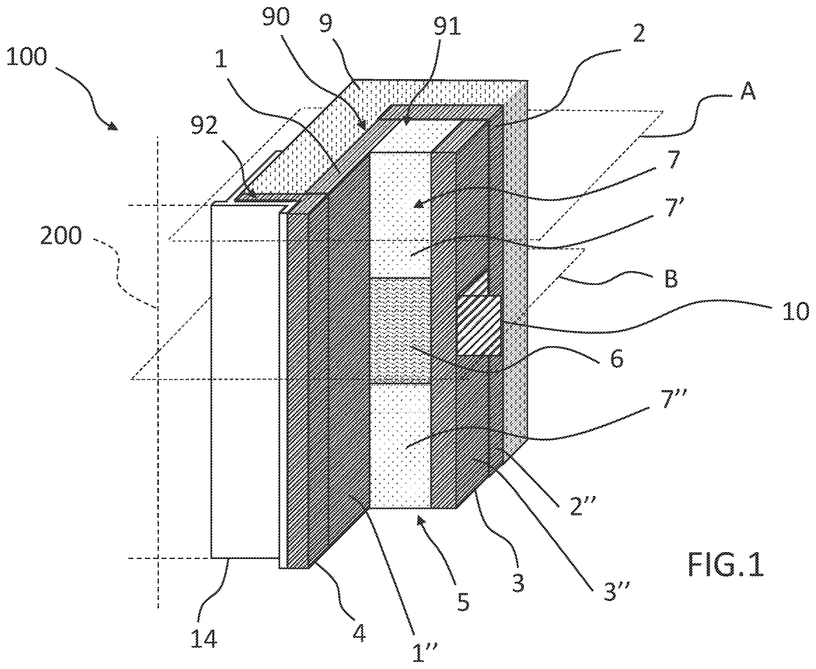

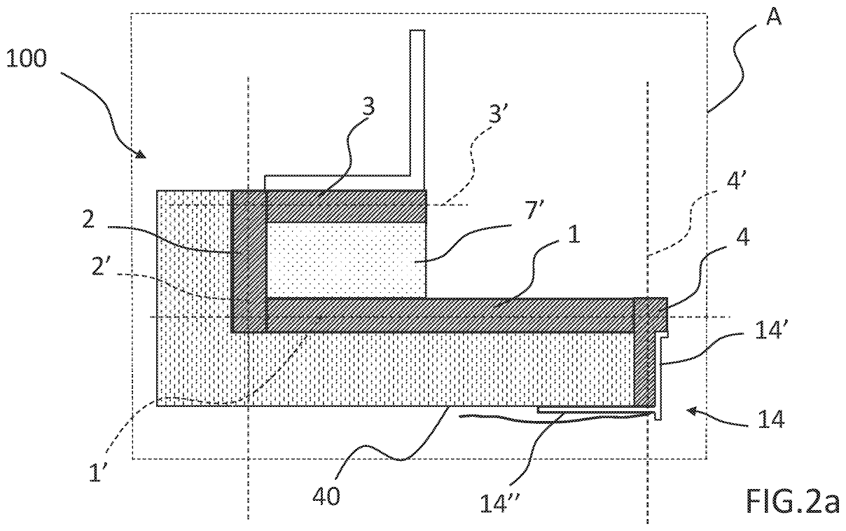

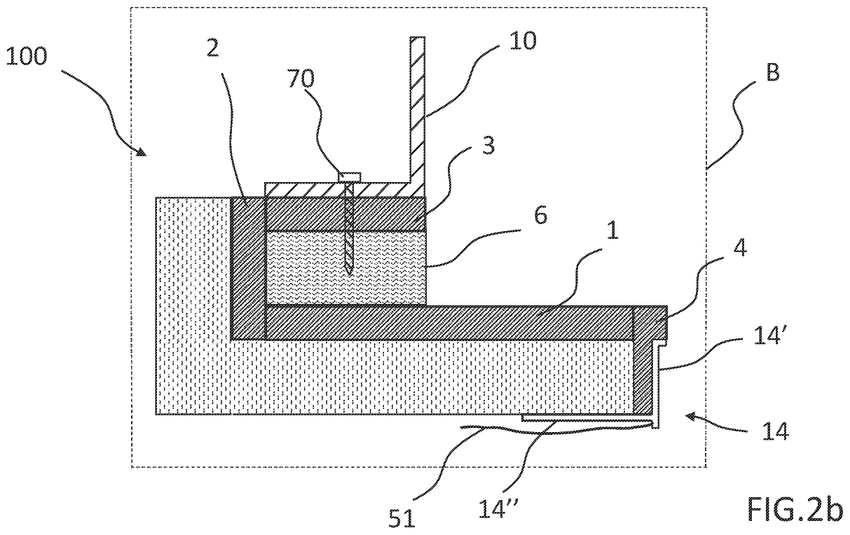

The covering element 100 comprises a supporting structure made of wood 90 which exemplarily consists of a first 1, a second 2, a third 3 and a fourth panel 4 in series with each other. Exemplarily, the supporting structure 90 has a constant section orthogonal to the main extension direction 200 when moving longitudinally. In other words, the sectional conformation of the supporting structure 90 (i.e., of the panels 1-4) does not vary depending on the longitudinal height of the covering element 100 at which the section is realized (like for example shown in FIGS. 2a and 2b showing two sections respectively on the planes A and B of FIG. 1).

Each panel 1-4 has a respective main extension plane, i.e. the plane (e.g. vertical in FIG. 1) defined by the two largest dimensions of each panel (typically, length and width). Each panel 1-4 typically has a thickness (i.e., the dimension orthogonal to the respective main extension plane) that is less (e.g., at least twice—for the second and fourth panel, or at least five times—for the third panel, or at least ten times—for the first shorter panel) than both the respective length and width. In FIG. 2a for each panel a dashed line (1′-4′) shows the section of the respective main extension plane (conventionally placed at half thickness). Each panel 1-4 has a respective first face and a respective second face opposite to each other and parallel to the respective main extension plane of the panel.

Exemplarily, the panels 1-4 have a rectangular shape both seen in plan and in the orthogonal section (FIGS. 2a-b). Exemplarily, the panels 1-4 are OSB panels.

Below, with reference to the figures and in particular to FIG. 1, the spatial orientation of the panels 1-4 constituting the supporting structure 90 is described.

The first panel 1 is rigidly connected (e.g. glued and/or fixed by mechanical fastening elements) to the second panel 2 at an end portion of the second panel 2. The latter, in turn, is rigidly connected to the third panel 3, with the third panel 3 being fixed to an end portion of the second panel 2 opposite to the end portion to which the first panel 1 is fixed. Exemplarily, the fourth panel 4 is rigidly connected to the first panel 1 on the opposite side with respect to the second panel 2, with the first panel 1 being fixed to an end portion of the fourth panel 4.

In the figures it is shown that a respective side edge of the panels 1 and 3 (i.e. the edge corresponding to the thickness) are in contact with end portions of the first face of the second panel 2 (so that there is coplanarity between the side edges—of which only one is shown with the reference number 2″—of the second panel 2 and a respective face of the first 1 and third panel 3—of which only face 3″ of the third panel 3 is shown), and that a respective side edge of the first panel 1 opposite to the second panel 2 is in contact with an end portion of the first face of the fourth panel 4 (respecting the aforesaid coplanarity). In any case, the present invention also contemplates embodiments in which the respective side edge of the second 2 and/or of the fourth panel 4 are in contact with end portions of the respective faces of the first 1 and/or third panel 3.

The main extension planes of contiguous panels in the series are perpendicular to each other, therefore the main extension planes of the first 1 and third panel 3 are parallel to each other and perpendicular to the extension planes of the second 2 and fourth panel 4, the latter being in turn parallel to each other.

The first 1 and third panel 3 extend on the same side of the second panel 2, or in other words, the respective main extension planes of the first 1 and third panel 3 have a same extension direction (i.e., spatial conformation like a “u” of the sequence formed by the first, second and third panel). The main extension plane of the fourth panel 4 has exemplarily opposite extension direction with respect to an extension direction of the main extension plane of the second panel 2, where the fourth 4 and second panel 2 extend at opposite edges of the first panel 1 (i.e., spatial conformation like a “z” of the sequence formed by the fourth, first and second panel).

The aforesaid arrangement of the panels 1-4 causes a pocket 91 to be formed between the first 1, second 2 and third panel 3, i.e. a space confined on three sides that extends along the entire longitudinal length of the covering element 100. For example, said pocket 91 is defined by the respective first faces of the first 1, second 2 and third panel 3.

A portion of the first face of the first panel 1, the first face (for the part left free by the first and third panel) of the second panel 2 and the first (whole) face of the third panel 3 define the pocket 91. Conversely, the remaining portion 1″ of the first face of the first panel 1 is free from the pocket 91. In other words, with reference to a direction perpendicular to the main extension plane of the second panel 2 (i.e. a direction parallel to the extension plane of the first and third panel), the third panel 3 has dimension (e.g., extension) smaller than the dimension (e.g., extension) of the first panel 1.

The covering element 100 comprises a filling assembly 5 housed in the pocket 91. Exemplarily, the filling assembly 5 occupies entirely the three-dimensional space defined by the pocket 91. For example, to stably fix the filling assembly 5 to the pocket 91, a respective adhesive layer (e.g. a glue) is provided between the first faces of the first 1, second 2, and third panel 3 and the three faces of the filling assembly 5 that contact the aforesaid first faces (in other words the filling assembly 5 is glued to the inner surface of the pocket 91).

Exemplarily, the filling assembly 5 comprises an insulating element 7 (in the example of FIG. 1 two distinct portions 7′ and 7″ of the insulating element are shown) made of insulating material, for example EPS reinforced with graphite.

Exemplarily, the filling assembly 5 also comprises at least one anchoring element 6, exemplarily made of wood and as a single piece. For example, the anchoring element 6 is a solid wood block. In FIG. 1, a single anchoring element is shown for simplicity of representation, however the covering element of the present invention more typically comprises more than one anchoring element housed in the pocket and longitudinally spaced apart from each other. Exemplarily, the anchoring element 6 has a longitudinal length equal to about 15 cm.

The insulating element 7 exemplarily extends overall for about 70% of the longitudinal length of the covering element 100, the remaining part being filled by the one or more anchoring elements 6.

The longitudinal dimension at which the anchoring element(s) 6 is positioned is dependent on the specific needs of the construction site in which the covering element 100 is installed, as better explained below.

Exemplarily, the covering element 100 comprises a fastening element 10 (or more typically a plurality of fastening elements) fixed to the second face of the third panel (i.e. the face of the third panel opposite to the first face defining the pocket 91). Typically, for each fastening element 10 there is a respective anchoring element 6.

Exemplarily (and typically), the fastening element 10 is fixed to the anchoring element 6, for example by means of mechanical fastening means 70 (e.g., a threaded screw) that cross the thickness of the third panel 3 and enter the anchoring element 6 (as schematically shown in FIG. 2b).

The fastening element 10 is for example a metal corner plate configured to fix the covering element 100 to a facade of the building (as schematically shown in FIG. 3).

The covering element 100 comprises a layer 9 made of insulating material, exemplarily XPS, which continuously covers the second face of the first 1 and second panel 2 (i.e. the faces of the two panels opposite to the respective first faces defining the pocket 91). Exemplarily, the layer 9 also continuously covers a first face of the fourth panel 4. In other words (as schematically shown in FIGS. 1 and 2a-b), the layer 9 has a thickness such as to be flush with the side edge of the fourth panel 4. The layer 9 can for example be fixed to the respective faces of the fourth 4, first 1 and second panel 2 by gluing.

Exemplarily, the fourth panel 4 comprises a recess 92 (shown in an accentuated manner for illustrative purposes) at a second face of the fourth panel 4 opposite to the first face of the fourth panel 4. Exemplarily, the recess 92 has minor surface extension of the second face of the fourth panel 4, and typically extends starting from the end portion of the second face of the fourth panel on the opposite side to where the coupling between fourth 4 and first panel 1 takes place.

Exemplarily, the covering element 100 comprises a support body 14 which exemplarily extends (as a single piece) over the entire longitudinal length of the covering element 100.

Exemplarily, the support body 14 comprises a first portion 14′ housed, in part, in the recess 92 and a second portion 14″ contiguous to the first portion 14′ and in contact with one face 40 of the layer 9 opposite to the first panel 1 (see FIG. 2a). For example, the support body 14 can be coupled to the covering element 100 by gluing the first portion 14 to the second face of the fourth panel 4 at the recess 92.

Exemplarily, the covering element 100 comprises (as shown in FIGS. 2a-b and 3) a levelling aid device, for example a net 51 fixed to the second portion 14″ of the support body 14.

As shown in the figures, the first portion 14′ of the support body 14 protrudes in the extension plane of the fourth panel beyond the recess 92 and the second portion 14″ to give a reference for the thickness of the levelling.

Advantageously, the covering element 100 described above is realized as a prefabricated element in a remote production site, and subsequently transported to an installation site, i.e. the site, for example a construction site, where the reveal 60 to be covered is present.

Typically, at the remote production site a covering system 150 of a reveal which comprises three, or exemplarily four, covering elements of the type described above is realized as a prefabricated. The covering system consisting of three covering elements provides that the three covering elements are fixed together in series to form a “U”. In other words, the respective main extension directions of the three covering elements lie in a same plane (i.e. are co-planar) and the main extension direction of the central element is perpendicular to the main extension directions of the terminal elements, with the terminal elements extending on a same side of the central element. In the case, for example, of a reveal of a rectangular compartment for window, the aforesaid covering system is then configured to cover the upper (horizontal) side of the reveal and the two lateral (vertical) sides of the reveal. In case the covering system comprises four covering elements, the fourth element is arranged in such a way as to close the profile defined by the other three elements, thus realizing a covering system also for the fourth side of the reveal (e.g., the horizontal lower side).

The Applicant has realized that, during production, it is possible to adapt each covering element 100 of the covering system 150 to the particular needs of the reveal to be covered and/or the conditions of the facade portion to be covered. For example it is possible to modify the dimensions of the covering elements of the covering system 150 according to the needs of the work site, and in particular by adjusting: i) the longitudinal length of each covering element 100, as a function of the height/width of the reveal, ii) the dimension (along the direction perpendicular to the extension plane of the second panel) of the portion 1″ of the first panel 1 free from the pocket 91, as a function of the depth of the portion of reveal left free by the window, with respect to the external facade of the building, iii) the dimension (along the direction perpendicular to the extension plane of the second panel) of the first 1 and third panel 3, as a function of the thickness of the thermal coat of the building.

The covering system 150 is fixed to the wall 31 of the building facade by taking advantage of the fastening elements 10, for example through one or more respective mechanical fastening elements 72 (e.g., threaded screws). In this way, the reveal 60 of the compartment of the window 65 is covered in a simple manner.

An airtight element 50 (e.g., a self-expanding adhesive) may be exemplarily coupled (e.g., by gluing) to the covering element 100. Said element 50 is for example glued to the first portion 14′ of the support body 14 on the opposite side to the second face of the fourth panel 4.

As shown in FIG. 3, once the covering system 150 is installed, one or more covering elements 100 are fixed to one or more support elements 95 for one or more respective accessory devices to the fixture, such as for example one or more hinges per roller shutter (not shown).

The support element 95 is fixed (for example by means of a suitable threaded screw 71 integral to the support element) to the second panel 2 so as to protrude from a free face 41 of the layer 9 parallel to the extension plane of the second panel 2. Exemplarily, as schematically shown, the fastening means 71 of each support element 95 crosses (perpendicularly) the second panel 2 and is fixed to the respective anchoring element 6.

In one embodiment not shown, the covering system may comprise one or more covering elements in which the filling assembly consists solely of the insulating element (i.e., it is devoid of the one or more anchoring elements), which entirely fills the respective pocket of the covering element. In this way the covering element has high thermal insulating properties. Such an embodiment turns out to be advantageous when said covering element covers a side of the reveal having a limited length, such as for example the upper and/or lower sides of a reveal. In fact, in this case, for the stable fastening of the covering system it is sufficient to provide fastening elements only at the covering elements that cover the long sides of the reveal (e.g., the vertical lateral sides). Furthermore, it is possible to anchor support elements to such a covering element, typically which do not have to bear high loads, such as for example a roller shutter-stopper, or, as schematically shown in FIG. 4, a plate 95′ for a balustrade, by means of for example a screw engaging the first panel 1 (entirely traversed) and third panel 3.

Once the reveal 60 has been covered (and the one or more support elements 95, 95′ fixed), a levelling operation (i.e. the application of a layer 68, for example of slaked lime) can be carried out at the free surface of the layer 9 (i.e. the entire surface of the layer 9 on the opposite side to the second faces of the first and second panels), in continuity with the levelling of the cover 32.

What is claimed is:

1. A covering element of a reveal, wherein said covering element comprises a supporting structure made of wood comprising a first, a second and a third panel rigidly connected to each other in series, wherein:
the second panel is interposed between the first and the third panel in the series;
the first and third panel are parallel to each other, they are perpendicular to the second panel and they extend on the same side of the second panel;
the first and third panel are connected to the second panel at respectively two opposite end portions of the second panel so that the first, the second and the third panel form a pocket,
wherein, with reference to a direction perpendicular to the second panel, the third panel has an extension smaller than an extension of the first panel,
wherein said covering element comprises a filling assembly housed in said pocket, and
wherein said covering element comprises a layer made of a first insulating material which continuously covers the first and second panel on opposite side to said pocket.

2. The covering element according to claim 1, having a main extension direction, wherein said supporting structure has a section orthogonal to the main extension direction which is constant when moving along the main extension direction, wherein, at each connection between two contiguous panels, a face of one of the two panels is coplanar with a side edge of another of the two panels, and wherein said first, second and third panels have a rectangular plan shape and are composed of wood chips and/or flakes and/or lamellae glued and compressed to each other.

3. The covering element according to claim 1, wherein said supporting structure comprises a fourth panel rigidly connected in series to the first panel, wherein said fourth panel is parallel to the second panel, wherein said fourth panel extends in opposite direction to an extension direction of the second panel, wherein the second and the fourth panel are connected to the first panel at two respective opposite end portions of the first panel, wherein said layer made of the first insulating material continuously covers also a face of the fourth panel facing towards the first panel, and wherein said fourth panel comprises a recess at a face of said fourth panel opposite to the first panel, and wherein said recess has a surface extension smaller than said face of the fourth panel opposite to the first panel.

4. The covering element according to claim 3, wherein said covering element comprises a support body which extends along an entire longitudinal length of the covering element, wherein said support body comprises a first portion housed in said recess and a second portion contiguous to said first portion and in contact with one face of said layer in the first insulating material opposite to the first panel, and wherein said covering element comprises:
an airtight element fixed to said first portion of the support body on the opposite side to the face of the fourth panel opposite to the first panel;
a levelling aid device coupled to said second portion of the support body.

5. The covering element according to claim 1, wherein said filling assembly comprises an insulating element made of a second insulating material, wherein said insulating element extends overall for at least 50% of an entire longitudinal length of the covering element, wherein said insulating element, in orthogonal section, entirely occupies said pocket and wherein said first and second insulating materials have a thermal conductivity less than or equal to 0.15 W/(m*K).

6. The covering element according to claim 1, wherein said filling assembly comprises one or more anchoring elements made of wood and each one as a single body, wherein each anchoring element has a longitudinal dimension greater than or equal to 10 cm, and wherein said one or more anchoring elements, in orthogonal section, entirely occupy said pocket.

7. The covering element according to claim 6, and comprising:
one or more fastening elements fixed to said third panel on opposite side to said pocket, each fastening element being configured to fasten said covering element to a facade of a building, wherein each fastening element is fixed to a respective anchoring element of said one or more anchoring elements;
one or more support elements of a respective accessory device for a fixture, each support element being fixed to the second panel and protruding from a free face of said layer made of the first insulating material parallel to said second panel, wherein each support element passes through said second panel and is fixed to a respective anchoring element of said one or more anchoring elements.

8. The covering element according to claim 1, wherein said first and/or second insulating material is selected from: sintered expanded polystyrene (EPS) reinforced with graphite, extruded expanded polystyrene (XPS), thermoplastic polyurethane (PUR), aerogel (of silica), polyisocyanurate (PIR), wood fiber, and combinations thereof.

9. A covering system of a reveal, the covering system comprising a first, a second and a third covering element, each of said first, second and third covering element comprising a supporting structure made of wood comprising a first, a second and a third panel rigidly connected to each other in series, wherein:
the second panel is interposed between the first and the third panel in the series;
the first and third panel are parallel to each other, they are perpendicular to the second panel, and they extend on the same side of the second panel;
the first and third panel are connected to the second panel at respectively two opposite end portions of the second panel so that the first, the second and the third panel form a pocket,
wherein, with reference to a direction perpendicular to the second panel, the third panel has an extension smaller than an extension of the first panel,
wherein said covering element comprises a filling assembly housed in said pocket,
wherein said covering element comprises a layer made of a first insulating material which continuously covers the first and second panel on opposite side to said pocket,
and wherein said first, second and third covering element are coplanar with each other and fixed in series to form a “U”.

10. A method for laying a covering system of a reveal, the method comprising:
prefabricating the covering system, the covering system comprising a first, a second and a third covering element, each of said first, second and third covering element comprising a supporting structure made of wood comprising a first, a second and a third panel rigidly connected to each other in series, wherein:
the second panel is interposed between the first and the third panel in the series;
the first and third panel are parallel to each other, they are perpendicular to the second panel and they extend on the same side of the second panel;
the first and third panel are connected to the second panel at respectively two opposite end portions of the second panel so that the first, the second and the third panel form a pocket,
wherein, with reference to a direction perpendicular to the second panel, the third panel has an extension smaller than an extension of the first panel,
wherein said covering element comprises a filling assembly housed in said pocket,
wherein said covering element comprises a layer made of a first insulating material which continuously covers the first and second panel on opposite side to said pocket,
and wherein said first, second and third covering element are coplanar with each other and fixed in series to form a “U”;
covering the reveal at least on three sides with the covering system.
